(19) United States
(12) Patent Application Publication
(10) Pub. No.: US 2016/0115778 A1
(43) Pub. Date: Apr. 28, 2016

(54) ADAPTIVE DRILLING VIBRATION DIAGNOSTICS

(71) Applicant: Board of Regents, The University of Texas System, Austin, TX (US)

(72) Inventors: Eric van Oort, Bee Cave, TX (US); Theresa Baumgartner, Austin, TX (US); Pradeepkumar Ashok, Austin, TX (US)

(21) Appl. No.: 14/920,712

(22) Filed: Oct. 22, 2015

Related U.S. Application Data
(60) Provisional application No. 62/069,052, filed on Oct. 27, 2014.

(51) Int. Cl. E21B 47/00; G06N 99/00; E21B 47/18; E21B 7/00; E21B 44/04; E21B 47/12

(52) U.S. Cl. CPC E21B 47/0006; E21B 44/04; E21B 47/12; E21B 47/18; E21B 7/00; G06N 99/005

(57) ABSTRACT

The disclosure relates to an adaptive system for diagnosing vibrations during drilling including a drilling assembly at least partially located in a wellbore, a sensor located in the wellbore, and a data processing unit. The drilling assembly may drill the wellbore. The sensor may detect high frequency data reflecting vibrations in the drilling assembly. The data processing unit may execute a classification model based on machine learning techniques which uses features extracted from the high frequency data to diagnose the type or intensity of a vibration or both in the drilling assembly. The disclosure further relates to an adaptive method of diagnosing vibrations during drilling by collecting high frequency data reflecting vibrations in a drilling assembly, extracting at least one feature from the high frequency data, and diagnosing the type of vibration using the at least one extracted feature and a classification model based on machine learning techniques.

### PRIORITY CLAIM

This application claims priority under 35 U.S.C. §119 to U.S. Provisional Patent Application Ser. No. 62/069,052 filed Oct. 27, 2014. The contents of which are incorporated by reference herein in their entirety.

### TECHNICAL FIELD

The present disclosure relates to adaptive systems and methods for diagnosing vibration in downhole components during drilling of a wellbore.

### BACKGROUND

In order to access subterranean deposits of oil, gas, or other valuable materials, a wellbore is drilled into the ground to at least the depth of these deposits. Drilling is accomplished by a drill bit attached to a drill string. Vibrations in the drill string during drilling are frequent and persistent drilling performance limiters. If vibrations become severe enough, they may damage various downhole tools. In addition, even mild vibrations slow drilling and may impair wellbore stability. Vibrations are currently classified as torsional, lateral, or axial. Corrective actions to address vibrations can be taken based on their severity and classification.

Accordingly, vibration models have been developed to represent downhole kinematics and dynamics to understand, detect, and mitigate vibrations. Some models, such as those currently employed with respect to stick-slip vibrations, are somewhat successful. Many early models, however, were too simplistic. Many of these simple models have been replaced with more complicated models, such as models involving finite element analysis. However, the more complicated models are limited by the calculation times required.

### SUMMARY

The disclosure relates to an adaptive system for diagnosing vibrations during drilling including a drilling assembly at least partially located in a wellbore, a sensor located in the wellbore, and a data processing unit. The drilling assembly may be functional to drill the wellbore. The sensor in the wellbore may be functional to detect high frequency data reflecting vibrations in the drilling assembly. The data processing unit may be functional to execute a classification model based on machine learning techniques which uses features extracted from the high frequency data to diagnose the type or intensity of a vibration or both in the drilling assembly.

The disclosure further relates to an adaptive method of diagnosing vibrations during drilling by collecting high frequency data reflecting vibrations in a drilling assembly located at least partially in a wellbore using a sensor located in the wellbore, extracting at least one feature from the high frequency data, and diagnosing the type of vibration using the at least one extracted feature and a classification model based on machine learning techniques.

### BRIEF DESCRIPTION OF THE DRAWINGS

The accompanying figures, which are incorporated in and constitute a part of this specification, illustrate several aspects and together with the description serve to explain the principles of the invention.

FIG. 1 illustrates an adaptive system for diagnosing vibration while drilling a wellbore in which high frequency data is transmitted to the surface for analysis.

FIG. 2 illustrates an adaptive system for diagnosing vibration while drilling a wellbore in which high frequency data is at least partially analyzed downhole.

FIG. 3A illustrates a method of training an classification model using machine learning techniques for diagnosing vibration while drilling a wellbore using high frequency data.

FIG. 3B illustrates another method of training a classification model using machine learning techniques for diagnosing vibration while drilling a wellbore using high frequency data.

FIG. 3C illustrates a method of diagnosing vibration while drilling a wellbore using a classification model based on machine learning techniques.

FIG. 4 illustrates types of vibrations that may be diagnosed using systems and methods of the disclosures.

FIG. 5A illustrates a two dimensional kinematic model of whirl type vibrations.

FIG. 5B illustrates orthogonal components of an acceleration vector used in the two dimensional kinematic model of FIG. 5A.

FIG. 6 illustrates simulated sinusoidal RPM variations during stick-slip.

FIG. 7 illustrates velocity and acceleration vectors during forward whirl.

FIG. 8 illustrates velocity and acceleration vectors during backward whirl.

FIGS. 9A-9F show field data (left) and kinematic model parameters (right) for radial accelerations.

FIGS. 10A-10F show field data (left) and kinematic model parameters (right) for tangential accelerations.

FIGS. 11A-11C show kinematic model-simulated data when the clearance between the drill string and borehole is varied while other parameters are kept constant.

FIG. 12 shows kinematic model-simulated data when the rotations per minute (RPM) of the drill string is held constant.

FIG. 13 shows kinematic model-simulated data when the drill string rotational speed and the whirl speed are held constant.

FIGS. 14A-14D show field data (left) and kinematic model parameters (right) for stick-slip.

FIGS. 15A-15E show field data (left) and kinematic model parameters (right) for radial accelerations with different eccentricities.

### DETAILED DESCRIPTION

The present disclosure relates to adaptive systems and methods for diagnosing vibration in downhole components during drilling of a wellbore.

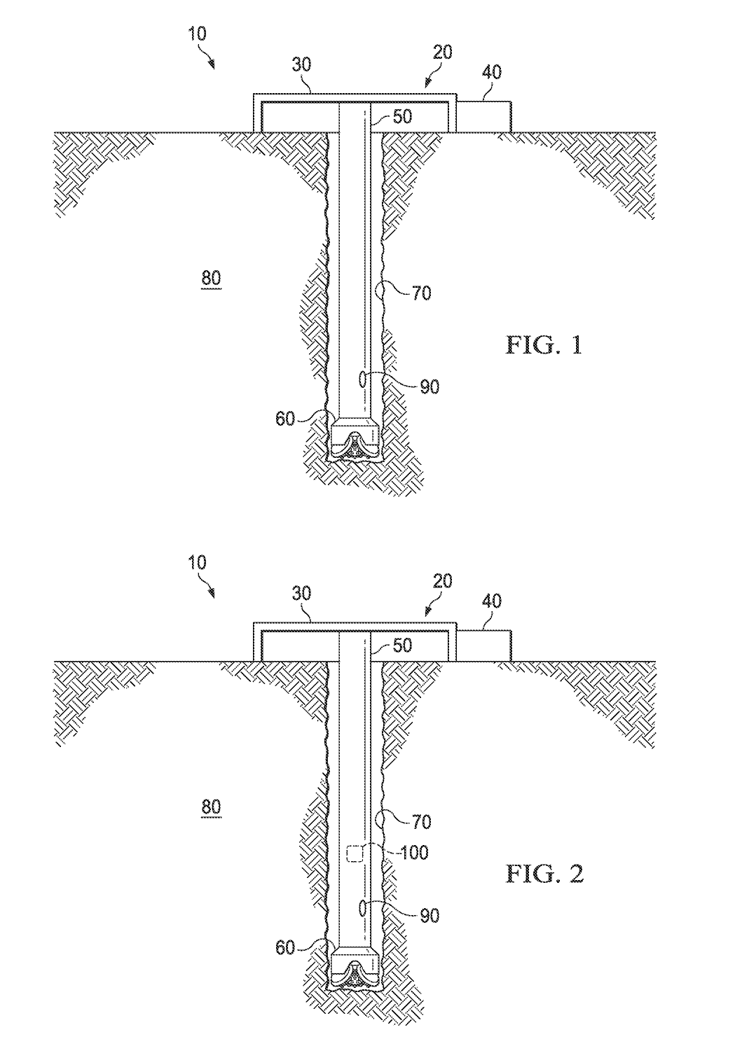

As shown in FIG. 1 and FIG. 2, an adaptive system 10 may include a surface assembly 20, including a support/driver structure 30 and a surface data processing unit 40. Adaptive system 10 may further include a drilling assembly, which may include a drill string 50 with attached drill bit 60, as well as other components, such as a bottom hole assembly and, potentially, some overlapping parts of surface assembly 20. Support/driver structure 30 may support and drive drill string 50 with attached drill bit 60 in order to form a wellbore 70 in a formation 80. The system also includes a downhole sensor 90 able to collect high frequency data that reflects vibrations in drill string 50. Downhole sensor 90 need not be a dedicated vibration sensor. System 10 may be used to diagnose vibrations using high frequency data from any type of accelerometer oriented in any direction and from weight sensors, torque sensors, and any other type of sensor in which a vibration causes an oscillation in high frequency data. The lack of dependence on directional vibrational sensors may lead to more accurate diagnoses or quicker diagnosis because as soon as the rotational axis of drill string 50 does not completely align with the center of wellbore 70, position, velocity, and acceleration of sensors may no longer be analyzed independently. As shown in FIG. 1 and FIG. 2, sensor 90 may be located on or in drill string 50, although other locations are possible. Sensors located closer to drill bit 60 may give more accurate information regarding vibrations.

As shown in FIG. 2, in which some data processing occurs downhole, downhole data processing unit 100 may also be present. Downhole data processing unit 100 may be separate from sensor 90 as shown, or it may be integral with sensor 90. Additionally downhole data processing unit 100 may be located on or in drill string 50, as shown, or it may be in another downhole location. Although typically even if downhole data processing unit 100 is present, surface data processing unit 40 will also still be present as shown in FIG. 2, it is possible that surface data processing unit 40 may be omitted or replaced with a control unit if all data processing is carried out in downhole data processing unit 100.

Data processing unit 40 and/or data processing unit 100, if present, may include a memory and a processor. Data processing unit and/or data processing unit 100, if present, may further include a control unit able to control at least some drilling operation parameters

Optionally, adaptive system 10 may include a surface alarm system (not shown) as part of or in addition to surface assembly 20. The surface alarm system may provide a visual warning or other type of warning to users in the vicinity. The alarm system may also be capable of automatically stopping drilling. The alarm system may be triggered by vibration type or intensity.

Although FIG. 1 and FIG. 2 illustrate vertical drilling for simplicity, adaptive systems and methods disclosed herein also be used in connection with any direction of drilling, such as horizontal or directional drilling.

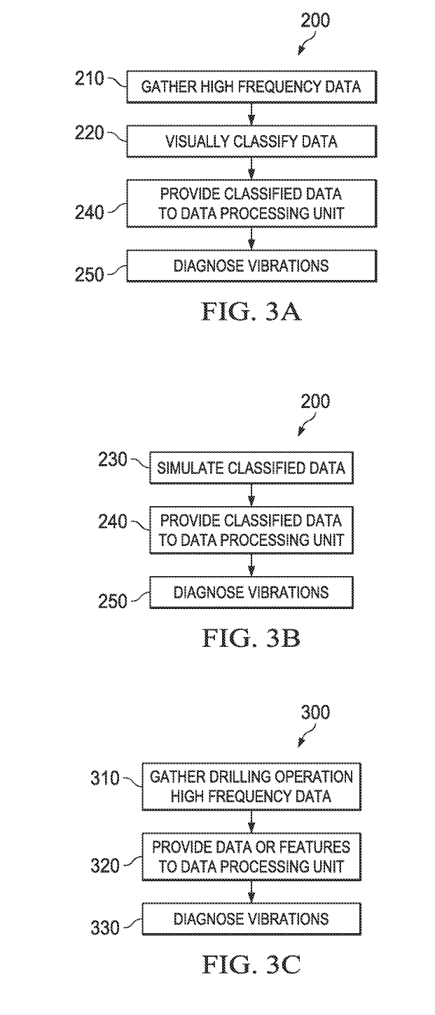

FIG. 3A illustrates a method 200a of training an artificial intelligence model for diagnosing vibration while drilling a wellbore using high frequency data. In step 210, raw data from at least one sensor present downhole during a drilling operation, such as sensor 90, is gathered. In step 220, this raw data is visually classified as corresponding to a vibration type. The raw data typically also represents vibration intensity. Features are extracted from the raw data either before or after visual classification and may form a part or all of the classified data. Features may be extracted by any methods of applying signal processing techniques. In step 240, the classified data is provided to a data processing unit able to execute the classification model. In step 250, the classification model is trained using the classified data and machine learning techniques.

FIG. 3B illustrates another method 200b of training a classification model for diagnosing vibration while drilling a wellbore using high frequency data. In this method, steps 210 and 220 are instead replaced by step 230, in which a simulation model, such as a kinematic model, is used to generate classified data. As with FIG. 3A, the classified data may include features either wholly or partially.

FIG. 3C illustrates an adaptive method 300 of diagnosing vibration while drilling a wellbore using a classification model based on machine learning techniques. The classification model based on machine learning techniques may be produced using the methods of FIG. 3A or FIG. 3B or another method able to produce a model able to diagnose vibrations using high frequency data. In step 310, drilling operation high frequency data is gathered from at least one sensor, such as sensor 90, during drilling. In step 320, this drilling operation high frequency data is provided to a data processing unit, such as data processing unit 40 or data processing unit 100, that is able to extract at least one feature from the data. The extracted feature is then provided to a data processing unit 40 or data processing unit 100 that is able to execute the classification model based on machine learning techniques using the drilling operation high frequency data to diagnose, in step 330 the type and, optionally, also intensity of any vibrations during drilling. Typically, the same data processing unit may extract features and execute the classification model, but these steps may be performed by separate data processing units.

In an optional step, not shown, this data coupled to the diagnosis may form classified data used in further training of the classification model. Often a subset to the data coupled to diagnosis may be used in further training

High frequency data is typically data at a frequency of 1 Hz or higher or, more specifically, 50 Hz or higher or even 100 Hz or higher. In the method of FIG. 3C or other methods of diagnosing vibration while drilling a wellbore, high frequency data may be provided to the data processing unit for execution of the classification model based on machine learning techniques as a continuous data feed. This may allow real time vibration diagnosis.

In systems and methods employing real time vibration diagnosis, a control unit may automatically or substantially automatically implement a corrective action to mitigate a diagnosed vibration, for example by changing a drilling operation parameter, such as RPM or weight on bit (WOB). Alternatively or in addition, an alarm may automatically be triggered.

Prior to execution of the classification model based on machine learning techniques either during training, such as that shown in FIG. 3A and FIG. 3B, or during vibration diagnosis while drilling, such as that shown in FIG. 3C, features are extracted from the high frequency data in windows of set lengths, for example between 0.5 and 60 seconds in length. Generally, a time window should be long enough to capture low frequency phenomena (e.g. stick-slip vibrations) and short enough to capture changes in drilling conditions and be allow reaction for controlling drilling parameters in real-time. The nyquist frequency theorem implies that sampling frequency should be twice as high as the frequency of interest. Features may be based on patterns in the high frequency data. The use of patterns in high frequency data is more useful in vibration diagnostics than absolute vibration values. It addition high frequency data patterns contain information not found in low frequency data. Features may include or be based on time, statistical data, smoothed data, frequency domain data, and combinations thereof. For example, features may include acceleration features such as root mean squared acceleration, maximum acceleration, minimum acceleration, acceleration frequency, and acceleration wavelet transforms. Features may also be extracted from data from additional sensors, surface data, and/or static data. Features may specifically not include individual data points, such as are typically used in conventional drilling vibration analysis. Thus, the classification model based on machine learning techniques may specifically not use individual data points to diagnose vibrations.

During execution of the classification model based on machine learning techniques, the features are correlated to the type of vibration, if any, and/or its intensity. Intensity of vibrations may be determined based on the average and maximum vibration levels for each sensor, such as sensor 90, or type of sensor. Typically, the same features extracted during training of an artificial intelligence model will be extracted for vibration diagnosis during drilling.

The artificial intelligence model used in adaptive systems and methods described herein may use a Bayesian approach and the following equation:

P(vᵢ\D)∝P(D\vᵢ)×P(vᵢ) (I)

in which D represents features extracted from high frequency data and possibly also additional features or data, Vᵢ represents vibration type, P(vᵢ) represents prior information is selected to match the type of drilling operations for which vibrations are diagnosed. The type of vibration is determined by which gives the maximum value for P (vᵢ\D).

The classification model based on machine learning techniques may also use neural networks or other forms of machine training and learning.

When methods of the present disclosure are carried out using a surface data processing unit, such as surface data processing unit 40 in FIG. 1 and FIG. 2, high frequency data from a sensor, such as sensor 90, may be transmitted to the surface using any available downhole-surface data transmission method, such as mud pulse telemetry or a wired drill string. The high frequency data may either be stored in the sensor or elsewhere downhole and transmitted periodically or it may be transmitted in real time.

If a downhole data processing unit, such as downhole data processing unit 100 in FIG. 2, is employed, the data processing unit may transmit refined high frequency data, extracted features, vibration diagnoses, commands, or other information other than raw data to the surface. Alternatively, downhole data processing unit 100 may be able to issue commands that are implemented downhole without the need for surface transmission.

In general, implementation of the systems and methods described herein allows the bulk of high frequency data to be discarded regularly, leading to an increase in time spent drilling, which is often limited by data storage capabilities. For instance, systems and methods described herein may allow data reduction to 500 to 1000 times as compared to current systems and methods. High frequency data may be reduced using an intelligent data reduction method. For example, this method may be applied before or during feature extraction. For example, as few as 16 data points every 10 seconds may be used to diagnose vibrations. In addition, the systems and methods described herein allow diagnosis of vibrations throughout a drilling operation.

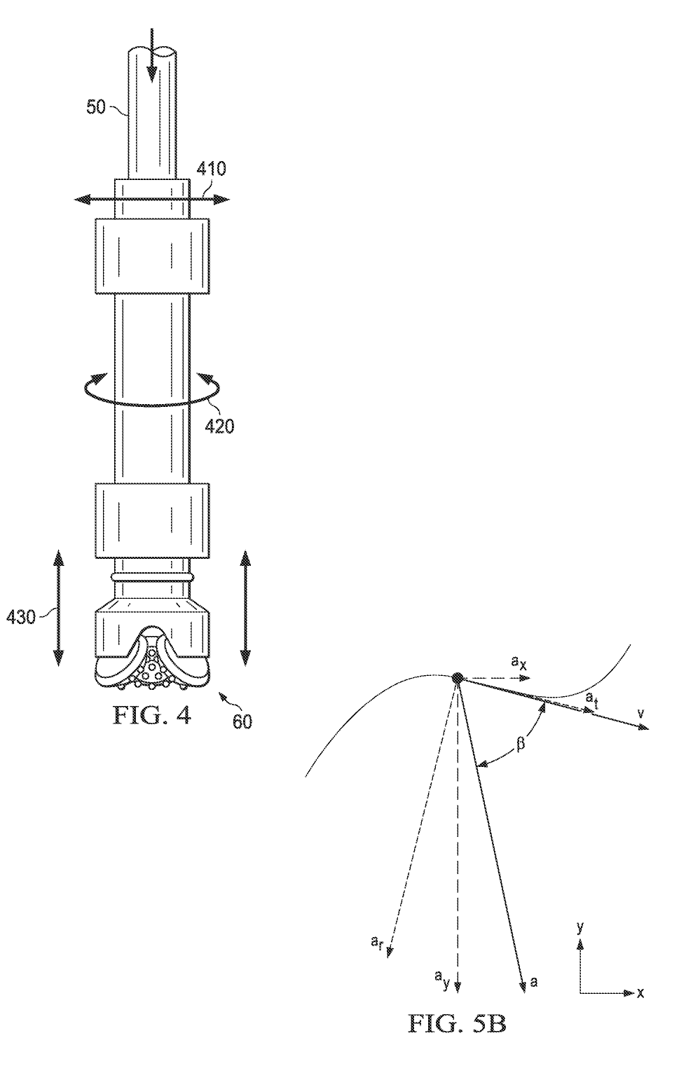

FIG. 4 illustrates types of vibrations that may be diagnosed using systems and methods of the current disclosure. For a drill string 50 with an axis of rotation 400, these types of vibrations include lateral vibrations, 410, which may further include bending and whirl, such as forward whirl and backward whirl, torsional vibrations, 420, which may further include stick-slip rotational fluctuations, and axial vibrations, 430 which may include bit bounce and jarring.

The type of lateral vibration most often of interest is whirl, which occurs when the rotational axis of the drill bit does not align with the center of the wellbore, so that the drill bit center performs additional rotations around the wellbore. Just like a spirograph, cutters on the drill bit leave patterns of hypotrochoid curves at the bottom of the hole. Equations for cutter positions during whirl and for whirl angular speed show similarities to the parametric equations for a hypotrochoid. Whirl is a high frequency phenomenon, with dominant frequencies in the range of 20 to 60 Hz, corresponding to the whirl angular speed. Whirl can occur in both backward and forward forms. Backward whirl occurs when the drill string rotates clockwise and the center (or axis of rotation) of the drill string rotates counter-clockwise around the wellbore. Forward whirl occurs when both the drill string and its center (or axis of rotation) rotate clockwise, but at different rotational speeds. Chaotic whirl may also occur when the center (or axis of rotation) of the drill string does not move in a particular direction but instead moves in a random and highly unstable fashion.

One corrective action for whirl is to stop drilling and wait until the whirl has terminated, then resume drilling with a higher WOB to prevent the drill bit from moving into an eccentric position once again.

Whirl patterns affect measured rotational speeds and accelerations as well as stick-slip and lateral measurements. Thus, diagnosed whirl vibrations may be used to correct measurements obtained from other sensors prior to taking any needed corrective action.

The type of torsional vibration most often of interest is stick-slip, which occurs when the rotational speed of the drill bit or drill string varies periodically with time. In severe cases, the drill bit may come to a complete stop, then move at several times the original rotational velocity. This pattern may then be repeated. Stick-slip may occur because the torsional strength of the drill string is too low to overcome high frictional forces between the cutters on the drill bit and the formation and/or stabilizers and the wellbore wall. During the stick portion of the cycle, the bit stops rotation, despite being supplied with a constant RPM from the surface. The drill string then winds up until enough torsional forces is applied to overcome the frictional forces, resulting in the slip portion of the cycle. Stick-clip is a low frequency phenomena, with a period ranging from less than 1 second to up to 10 seconds.

Corrective actions for stick-slip include adjusting torque and/or rotational speed.

Axial vibrations are excited through interactions between the drill bit and the formation being drilled. They are particularly prevalent with tri-cone drill bits. Axial vibrations can also be introduced by downhole tools such as agitators or jars.

Corrective actions for axial vibrations include adjustments to WOB or to drill bit design.

The simulation model, such as simulation model 230, may include a kinematic model to reproduce patterns of expected sensor data in different scenarios, for example position, velocity and/or acceleration data, which are further used and provided to the data processing unit and used for training Example scenarios include whirl, stick-slip, no fault, axial vibrations, and trajectory. Models may also be developed for different types of drilling operations with different drilling operation parameters, such as drilling at particular rotations per minute (RPM), with a given weight on bit (WOB), or a given mud type.

The kinematic model described as follows may be used to simulate whirl. Similar models for simulation of other types of vibrations may be developed by one of ordinary skill in the art using this kinematic model and any other portions of the disclosure.

The kinematic whirl model represents wellbore kinematics in two dimensions as a planar disk rotating in a confining, perfectly round circle. Effects of gravity, contact forces between the wellbore and the drill string, viscous dampening forces, friction forces, more complex drill bit and stabilizer geometries, interactions between inner and outer portions of the drill string (e.g. cutting actions) and any other dynamic effects are ignored.

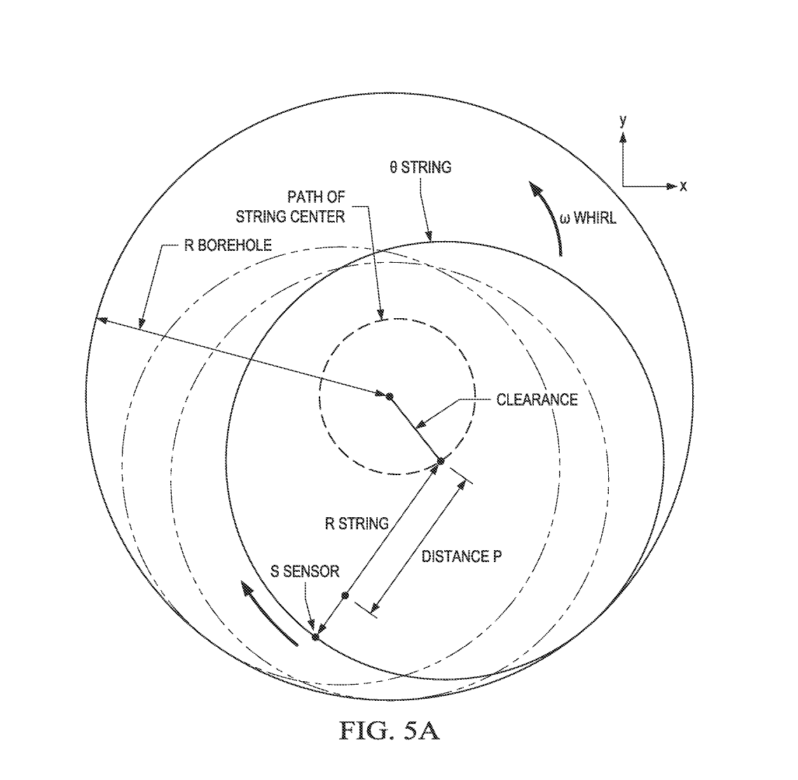

FIG. 5A shows a two dimensional model of a drilling as a planar disc. A circle with radius r represents the drill bit, such as drill bit 60, drill string, such as drill string 50 or other rotating element that rotates eccentrically in a circle of radius R, which represents the wellbore, such as wellbore 70. The center of the drill string follows a circle with angular velocity ω and radius δ, which equals R−r, while the drill string or radius r rotates around its center with angular velocity θ. A velocity or accelerometer sensor is represented as a point S at a distance p from the center of the drill string. For simplification, sensor position p may be set to be equal to drill string radius r, assuming the sensor is located on the outer drill string wall. The wellbore and drill string are viewed from above and the positive direction of angular velocities ω and θ are counter-clockwise. The drill string always rotates counter-clockwise with angular velocity ω, while the drill string center rotates with angular velocity θ in a counter-clockwise direction for forward whirl and in a clockwise direction for backward whirl. The coordinates of the sensor point S are given by superposition of the two movements, x_{f} and y_{f} for forward whirl, and x_{b} and y_{b} for backward whirl.

If accelerometers are placed in radial or tangential directions of the drill string, they measure accelerations in the moving frame of reference of the drill string. In particular, if multiple multi-axes accelerometers are used, one may transfer the measured tangential and radial accelerations back to the inertial reference system of the wellbore to yield x and y components of the acceleration vector. First and second time derivatives yield velocities and accelerations in x and y directions in a Cartesian coordinate system. In this kinematic whirl model, the sensor point moves in the rotating frame of the reference system. It simulates the actual acceleration experienced and measured by an accelerometer at the sensor point. Post-processing methods for acceleration data may be used to transfer measurements from a body-fixed frame or reference (such as a sensor on a moving drill string) to the inertial frame of reference of the wellbore.

Forward whirl may be modeled using the following equations:

x_{f}(t)=+δ cos ωt+r cos θt (II)

y_{f}(t)=−δ sin ωt−r sin θt (III)

x_{f}′(t)=v_{xf}(t)=−δω sin ωt−rθ sin θt (IV)

y_{f}′(t)=v_{xf}(t)=−δω cos ωt−rθ cos θt (V)

x_{f}″(t)=a_{xf}(t)=−δω² cos ωt−rθ² cos θt (VI)

y_{f}″(t)=a_{yf}(t)=+δω² sin ωt−rθ² sin θt (VII).

Backward whirl may be modeled using the following equations:

x(t)=+δ cos ωt+r cos θt (VIII)

y(t)=+δ sin ωt−r sin θt (IX)

x_{b}′(t)=v_{xb}(t)=−δω sin ωt−rθ sin θt (X)

y_{b}′(t)=v_{yb}(t)=+δω cos ωt−rθ cos θt (XI)

x_{b}″(t)=a_{xb}(t)=−δω² cos ωt−rθ² cos θt (XII)

y_{b}″(t)=a_{yb}(t)=+δω² sin ωt−rθ² sin θt (XIII).

In a vector representation shown in FIG. 5B, β is the angle between the direction of acceleration and velocity. Tangential and radial acceleration components aₜₐₙ(t) and a_{rad}(t) are orthogonal, while the tangential acceleration points in the direction of the velocity. Tangential and radial components are calculated separating tangential and radial components of the acceleration vector using the following equations:

aₜₐₙ(t)=a(t)cos β(t) (XIV)

a_{rad}(t)=a(t)sin β(t) (XV),

wherein β is the angle between velocity and acceleration vectors and may be calculated using the following equation:

$$β ( t ) = {cos}^{- 1} ( \frac{[ \begin{matrix}{a}_{x} ( t ) \\ {a}_{y} ( t )\end{matrix} ] \cdot [ \begin{matrix}{v}_{x} ( t ) \\ {v}_{y} ( t )\end{matrix} ]}{\vert a ( t ) \vert \cdot \vert v ( t ) \vert} ) . \qquad ( XVI )$$

The relationship between whirl frequency and rotational speed of the drill string for pure rolling motion without slip may be calculated using the following equation:

$$ω = \frac{r}{( R - r )} θ . \qquad ( XVII )$$

Varying friction factors between wellbore and drill string in reality could allow for varying amounts of tangential slippage, and the relationship of drill string angular speed and whirl speed could vary significantly from the given ratio. In the kinematic model, whirl angular speed and drill string angular speed can be varied both dependently (with the given ratio) or independently.

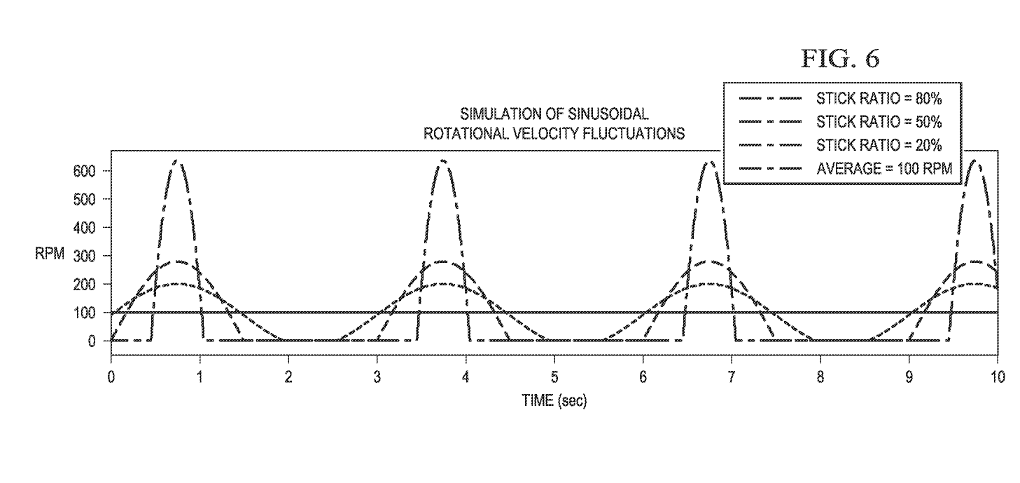

In addition to lateral whirl vibrations, the kinematic model may be used to represent stick-slip to investigate patterns of coupled vibration. The sticking and slipping periods are modeled by introducing a sinusoidal function for drill string and/or whirl angular velocities. The period of the stick-slip cycle is variable, as well as the percentage of stick time in percent of the total cycle. The signal is adjusted, such that the average of the stick-slip representation equals a constant angular velocity input. During stick-slip, unless active stick-slip mitigation systems control the torque, the surface RPM input is constant, which has to result in the same average downhole RPM. FIG. 6 shows simulated sinusoidal RPM variations: For a stick ratio of 80%, the peak angular velocities reach more than 6 times the average RPM input. Forces acting on the drill sting during these slip cycles can be expected to follow a comparable trend.

A graphical user interface allows for variation of the input drilling operation parameters and to study their effect on the displacement, velocity and acceleration components, which are displayed on a time vs. magnitude (m, m/s or g) scale. A Fast Fourier Transform (FFT) of the time-dependent signal allows for characterization of the output signals through its frequency peaks and their amplitudes.

Input drilling operation parameters in this model are:

Type of whirl (forward or backward)

Wellbore geometries: Drill string radius, position of the sensor within the drill string, eccentricity of the drill string

Angular velocities of drill string and whirl

Sampling frequency of the simulated data

Stick-slip: the angular velocity of the drill string and/or whirl changes from a constant to a sinusoidal function as described above

In addition, the simulator used in connection with the model may allow for dynamic visualization of the whirling motion, including whirl lobes in the borehole and dynamic vectors of velocities and acceleration at every time instance.

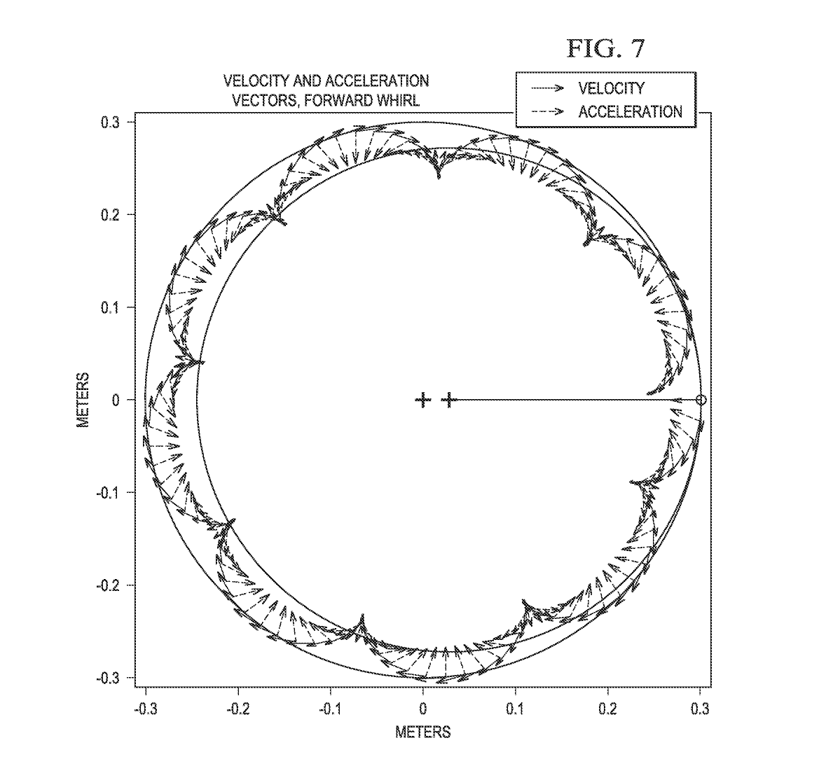

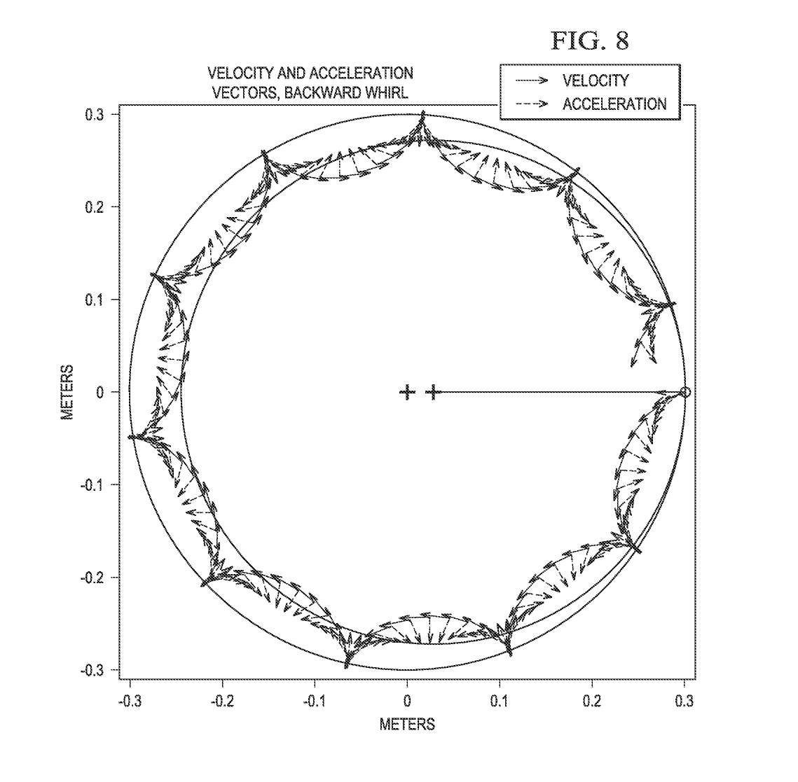

The previously-mentioned equations and velocity and acceleration vectors (Equations II-XVI) may be applied during forward whirl (FIG. 7) and backward whirl (FIG. 8) during one whirl revolution (rotation of the drill string center once around the borehole). The velocity vectors in both cases change their direction in each of the small lobes between the outer and the inner circle.

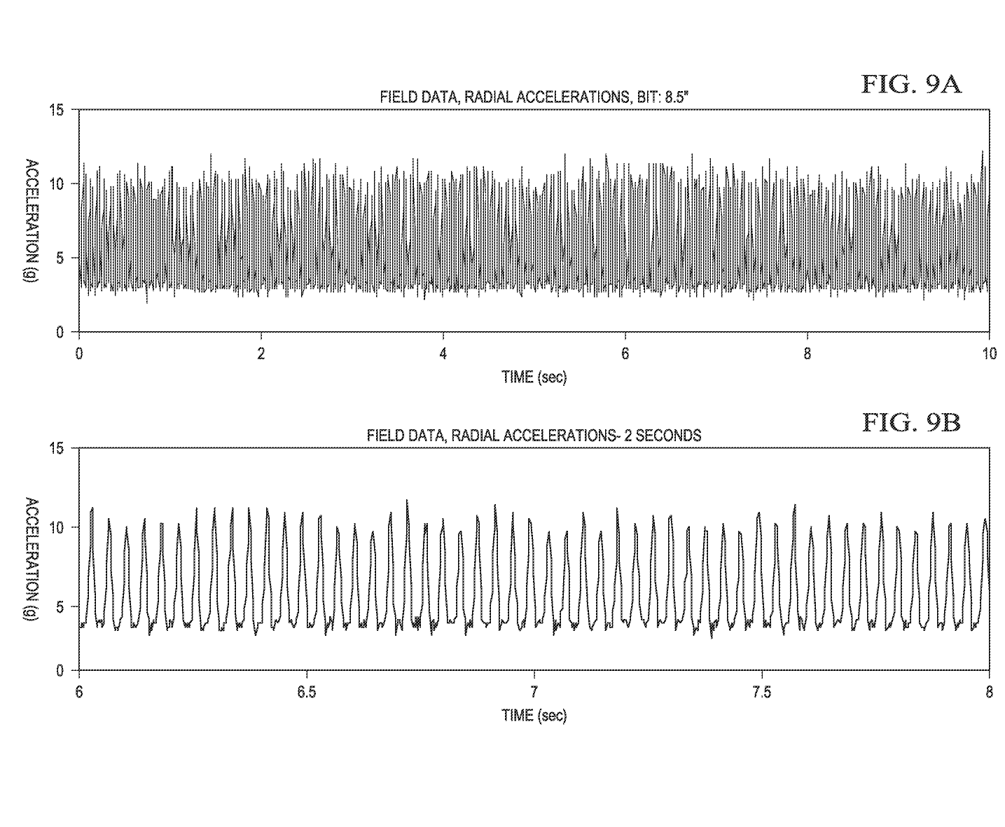

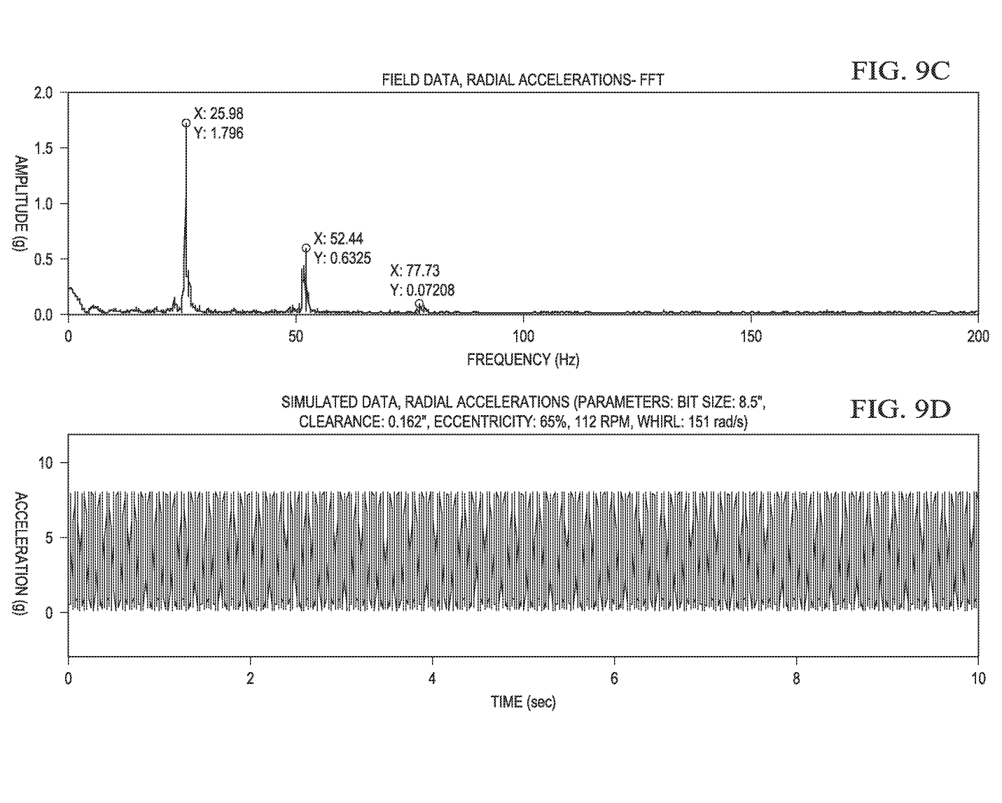

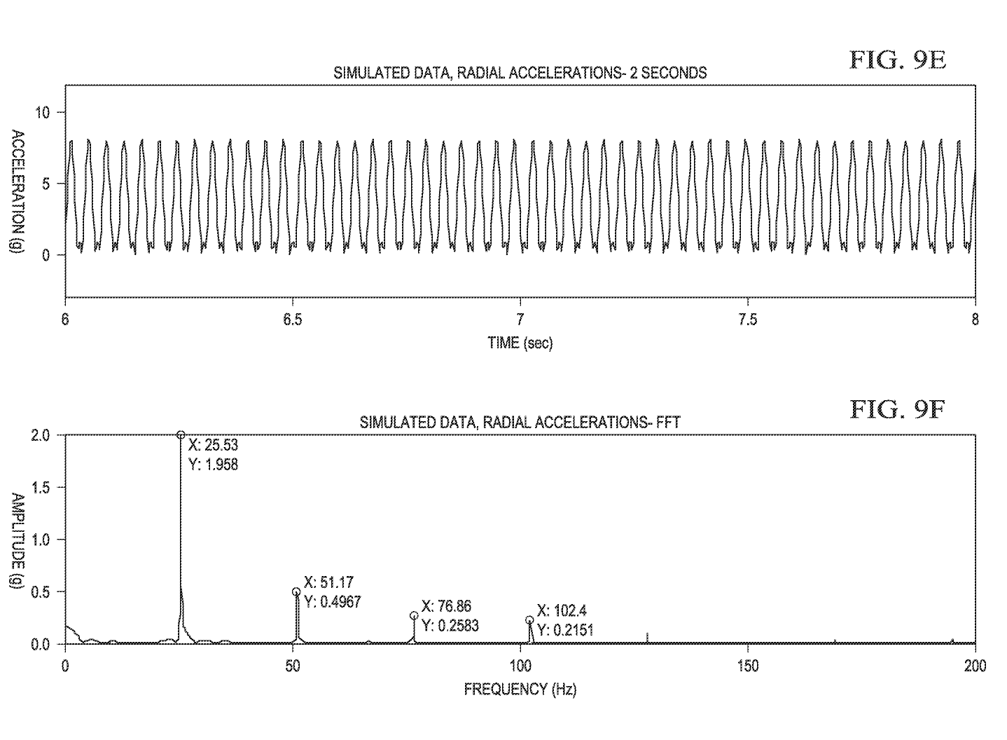

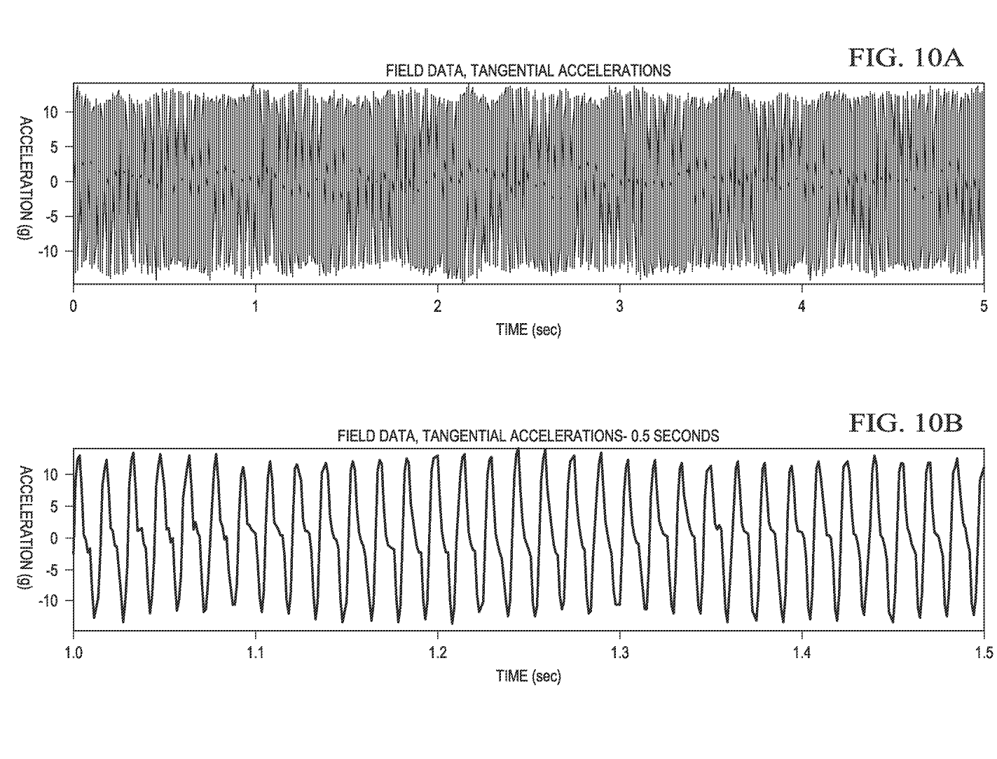

The output of the simple kinematic model was compared to field data that had been recorded during actual field drilling operations using stand-alone vibration measurement devices with data recording capabilities. The field data sampling rate was either 400 Hz or 800 Hz. FIGS. 9A-F show that field data of radial accelerations and model outputs correspond well. A Fast Fourier Transform was used to characterize the frequency response of the system. The sampling frequency of the model matches the sampling frequency of the field data. For the comparison of model results and field data, known parameters were unchangeable model inputs, such as a bit size of 8.5″ or RPM (revolutions per minute of the drill string) value of 112. The peak of characteristic frequency and its approximately equidistant overtones depend mainly on the whirl speed. Other parameters such as type of whirl (forward/backward), clearance, whirl speed, and eccentricity can be used as fitting parameters for acceleration amplitudes. Forward whirl and backward whirl showed similar responses in both the time and frequency domain. In this case, backward whirl was chosen for the representation of the field data because of a better match of the patterns. The field data shows an offset of 2.5 g from 0 that could possibly be attributed to higher clearance values or potential issues with calibration of the sensor.

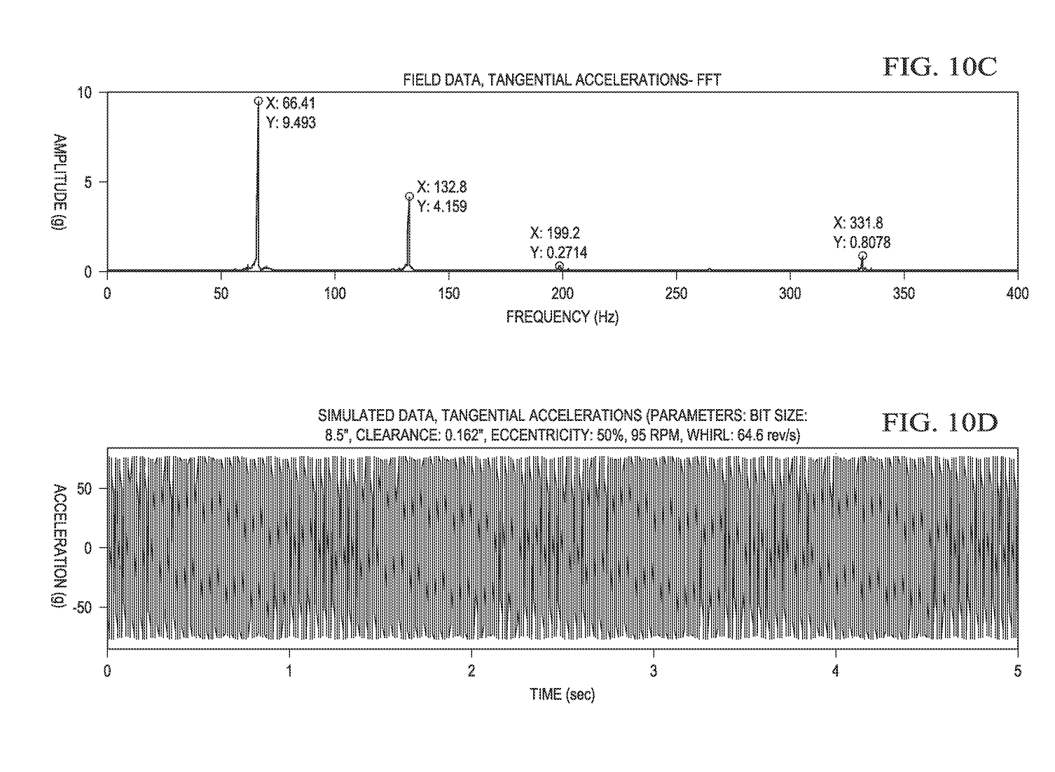

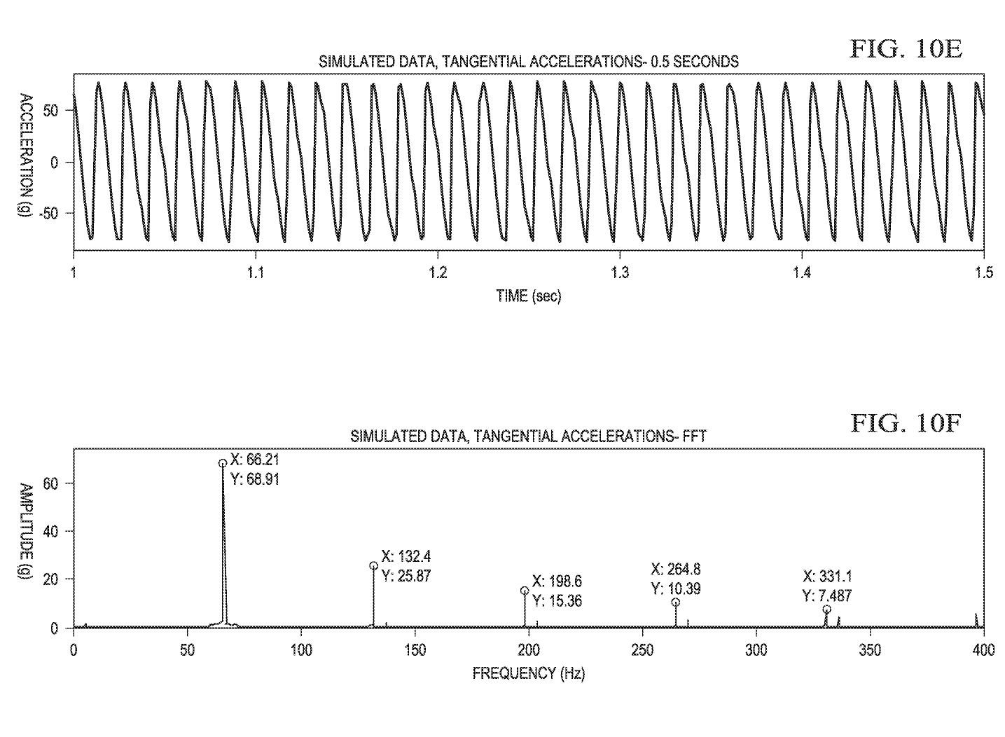

FIGS. 10A-F show similar results for tangential accelerations. The data was collected from a downhole memory tool with multiple tangential accelerometers. No post-processing was performed on the selected signal that was recorded from one of the accelerometers. Again, the model was able to match the patterns, both in time and frequency domain. The dominant frequency of tangential acceleration (66.4 Hz) and whirl angular speed (64.4 rev/sec), are very close but not identical. Modeling the dominant frequency peak using high whirl angular speeds results in very high acceleration levels, which are not observed in field data. The differences in vibration intensity could be attributed to:

Dynamic effects, such as dampening/cushioning of fluids, forces due to interactions between drill string and wellbore wall (lateral bit bounces), or bit/rock interactions.

Uneven shapes of the wellbore, cutters on the bit and stabilizer geometries could excite additional vibrations.

Noise from various sources such as the motor or surface equipment.

Interference with axial modes of vibrations that the two dimensional model does not incorporate.

Design of the measurement device: The levels measured by accelerometers in MWDs and stand-alone vibration subs differ significantly.

The maximum allowable eccentricity due to the bending of the drill string varies along the drill string.

Placing of the tool within the drill string has an effect on the maximum allowable bend of the string at the position of the sensor. Reduction of eccentricity lowers acceleration levels.

Any additional noise in the signal reduces the amplitude of a peak and broadens its base within a frequency spectrum.

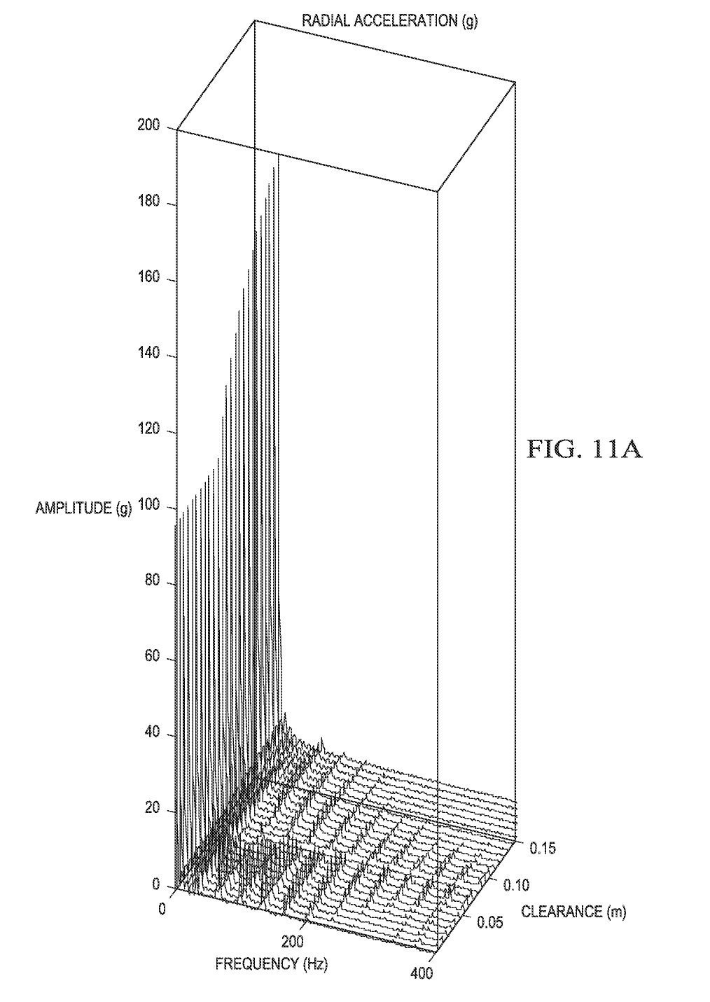

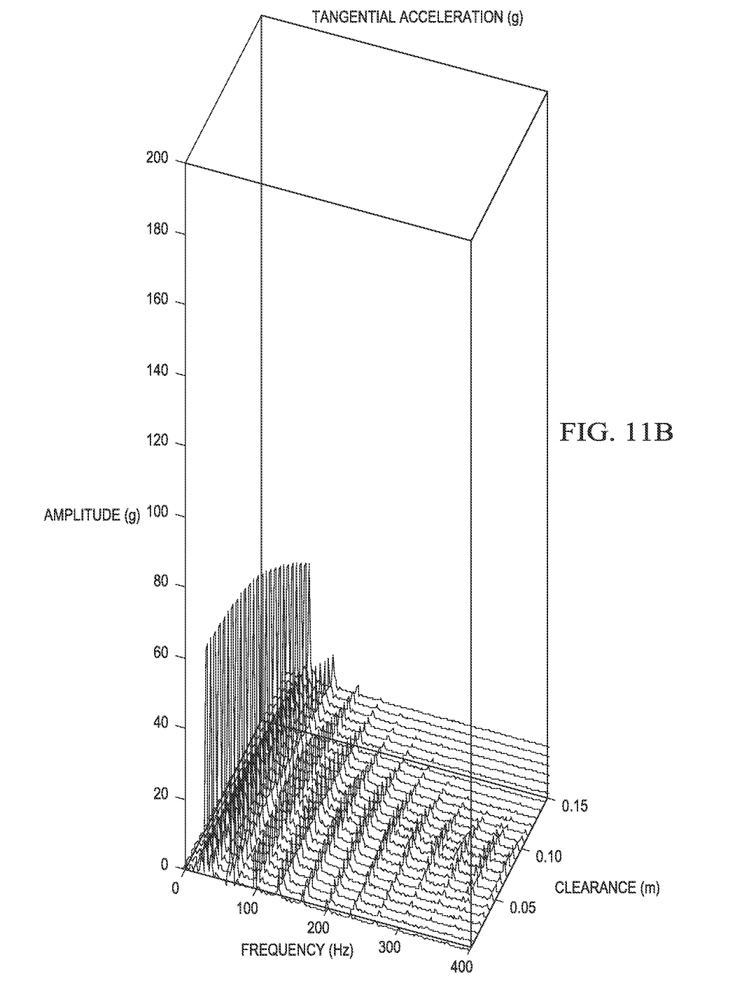

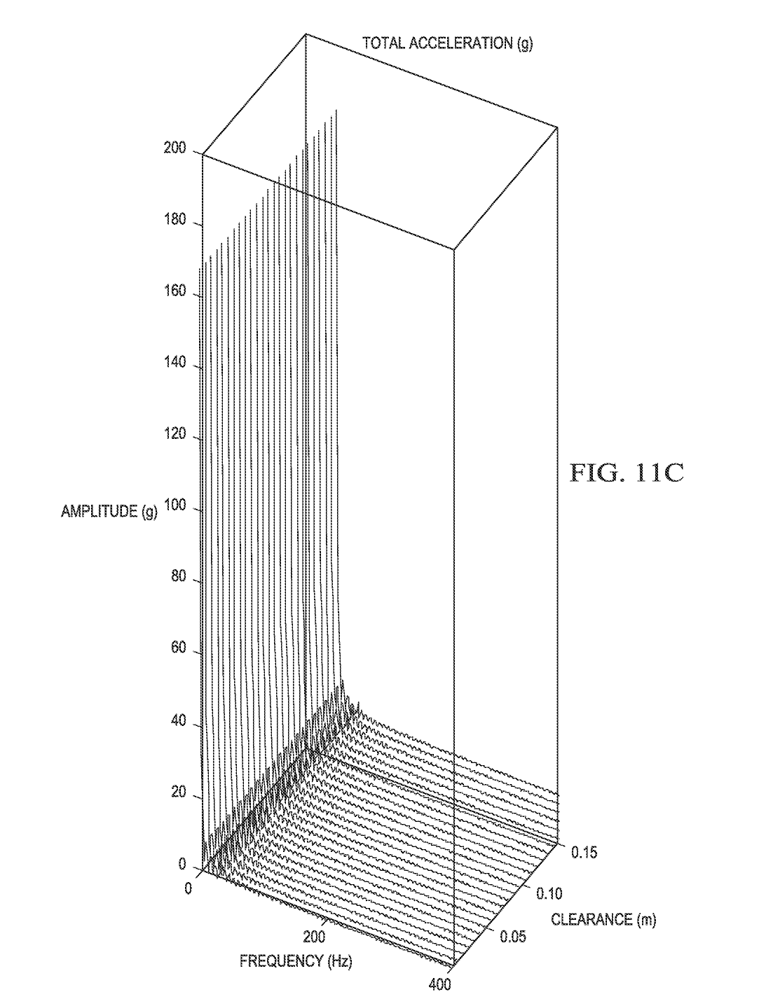

In FIGS. 11A-C, the clearance between the wellbore and the drill string is varied while all other drilling parameters are kept constant. Radial, tangential and combined accelerations are displayed in the frequency domain, performing a Fast Fourier Transform of the signal for each of the incremental changes in clearance. Radial acceleration levels of the dominant frequency increase with increased clearance while tangential levels decrease, with a compensatory effect on the combined acceleration values. The wellbore radius is set to 0.3 m. When the drill string radius is exactly half the wellbore radius, the frequency overtones disappear in the radial acceleration signal, while they reach a peak in the tangential accelerations.

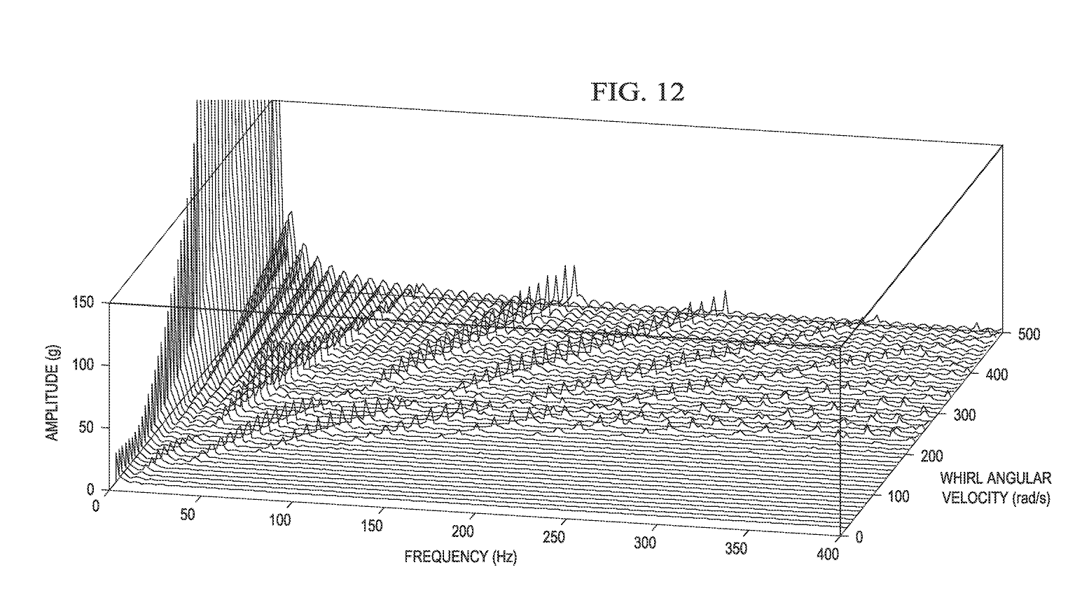

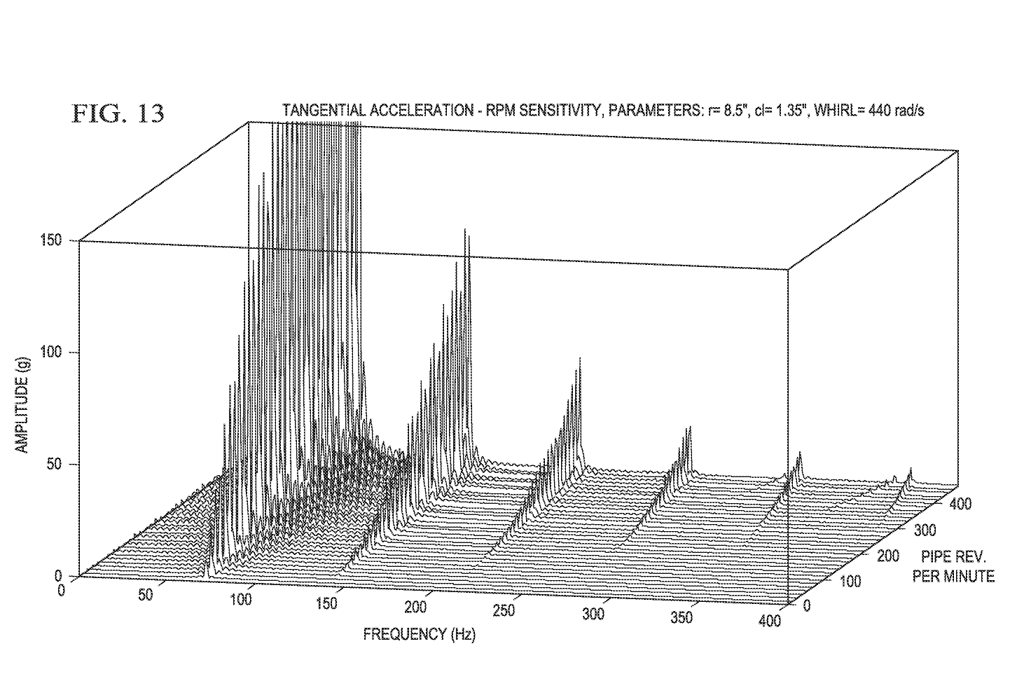

FIG. 12 and FIG. 13 demonstrate the sensitivity of radial and tangential acceleration peaks on drill string and whirl rotational velocities. The periodicity of the overtones (peak distances) increases with increasing whirl speed (FIG. 12): the peaks ‘spread out’. The frequencies of tangential accelerations of the simulation are completely independent from the RPM value of the drill string (FIG. 13).

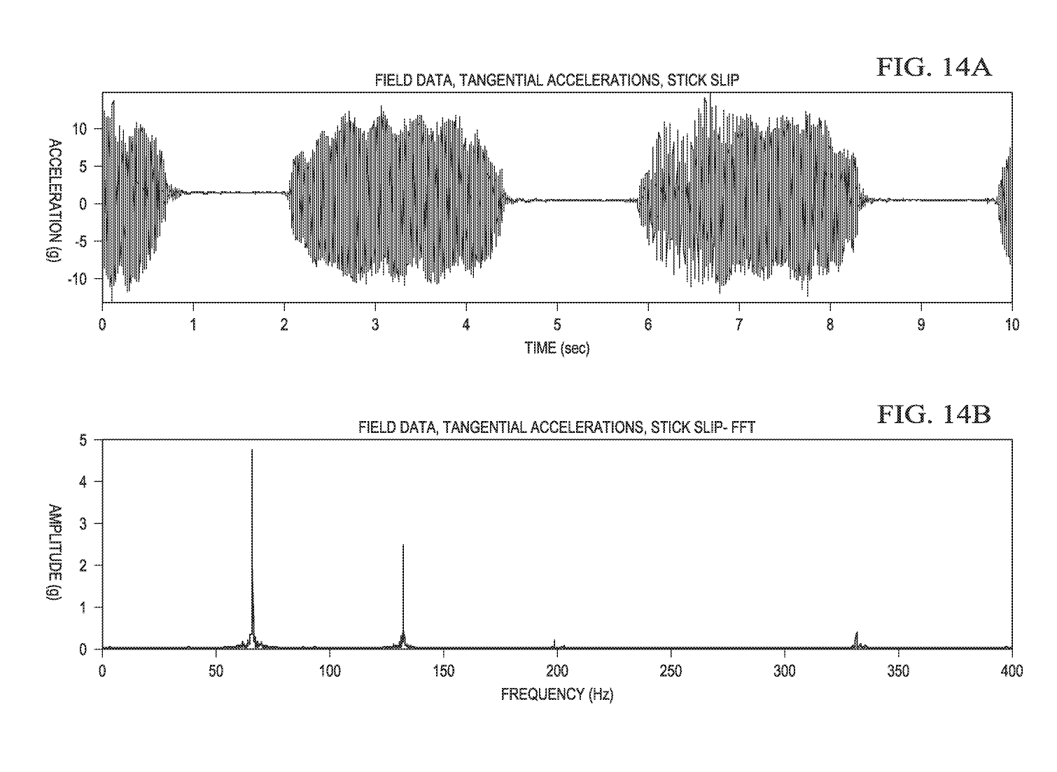

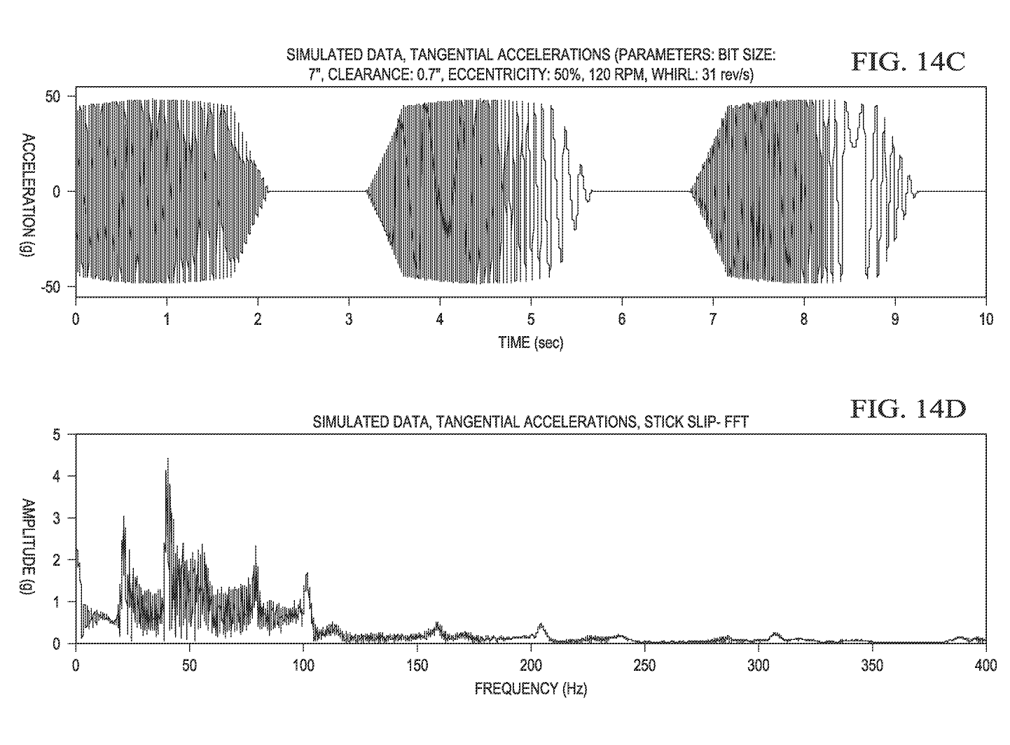

FIGS. 14A-D compare the tangential acceleration component from field data with simulated output generated using the kinematic model. The simple kinematic model with a sinusoidal drill string rotational speed fails to accurately reproduce the measured data. Stick-slip is modeled by a sinusoidal RPM variation where both the stick-slip period and the ratio of stick time to slip time are model inputs based on the data. The frequency spectrum of the modeled data is greatly influenced by the constant variation of the input. The shape of the tangential acceleration during the slip phase represents a square shape rather than a sine wave shape, which can be reproduced by the model when the clearance is reduced to 0.7″.

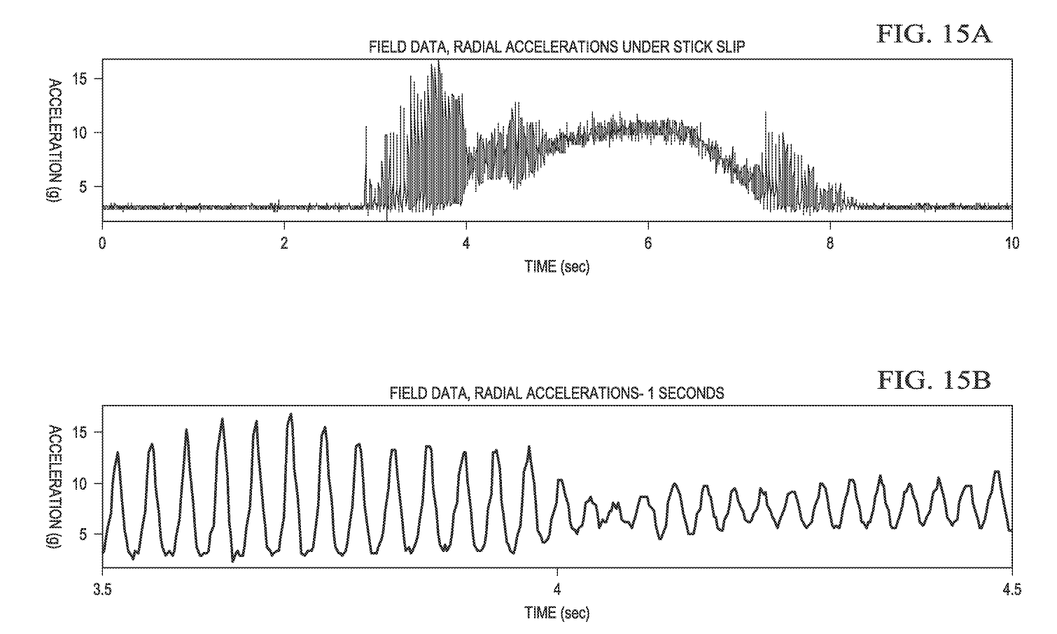

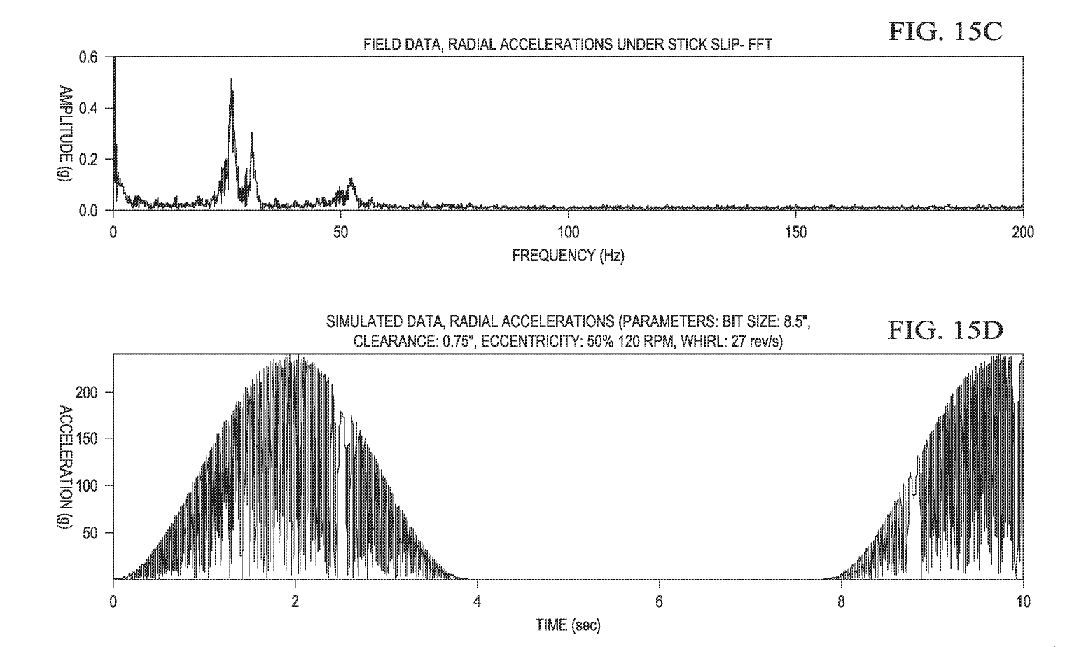

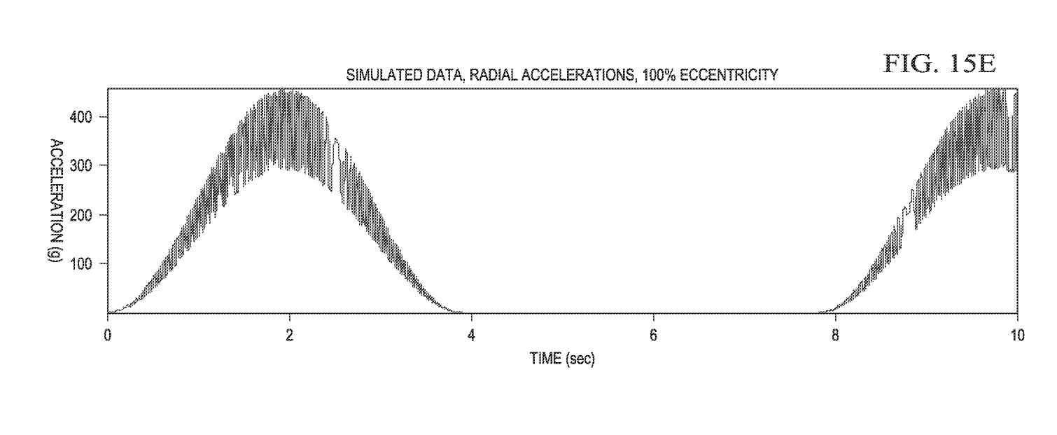

FIGS. 15A-E show radial accelerations during a long stick-slip cycle (period of 8.5 seconds). In the field data on the left, whirl patterns appear, just as the RPM values start to raise. The fluctuations disappear when a certain speed is reached and come back again at the end of the slip cycle with low RPM. This pattern occurred throughout the drilling. On the right, in the model-simulated data, the output signal from the simulation shows two patterns: In the upper plot, the amplitude reaches from zero to its maximum value, while in the bottom plot the amplitude fluctuates between two high acceleration levels. In the simulation, a change of the following parameters can cause the variation of patterns from top to bottom: Change of eccentricity from low (e.g. 50% to high e.g. 100%), change in whirl speed from low to high or sinusoidally fluctuating speed of both whirl and drill string in the top and only drill string in the bottom. From field data it is apparent that one or more parameters abruptly changed within the stick-slip circle to cause the change in patterns. Thus, in the simulated pure whirl situation, the magnitudes of tangential and radial accelerations reach similar levels. Radial accelerations calculated with this model are always positive, for example fluctuating between 0 and 10 g while tangential accelerations with the same parameters would vary between −9 and 9 g. In the case of stick-slip or fluctuations in drill string RPM, radial accelerations reach much higher levels than tangential accelerations. For the rotation around a fixed center with constant radius, the tangential acceleration is a function of the change of the magnitude of velocity with time (aₜ=d\v\/dt (XVIII)) while radial acceleration is a function of the velocity squared (ar=v²/r (XIX). Similarly, in the more complex simulation, the high velocities during stick-slip have a stronger influence on the radial than on the tangential component.

The comparison of kinematic model parameter outputs and real time data shows that high frequency fluctuations of both radial and tangential acceleration are solely an effect of eccentric rotation of the drill string. The kinematic model discussed above does not incorporate any three dimensional geometries or dynamic effects that would allow attributing these simulated frequencies to natural frequencies of the drill string or any other components of a drilling system. The modeled-simulations were not meant to reproduce factors affecting the onset of vibrational dysfunctions, rather, they were instead designed to link the measured data to downhole kinematics. With this, the model offers a way to unambiguously differentiate whirl and stick-slip patterns.

The kinematic model is also capable of reproducing patterns of accelerations in radial and tangential directions, which can verified with recorded field data in both the time and frequency domain. The dominant frequency of the signal and its overtones in this simplified mathematical representation are independent from the rotational speed of the drill string, while the amplitude increases with increasing RPMs.

The similarity of whirl patterns with the model parameters suggests that dynamics (such as dampening effects of the mud, elasticity of the wellbore, more complex wellbore geometries, etc.) have either more or less constant dampening effects or the acceleration measurements are to a large part dominated by kinematic effects, such that the dynamic effect become invisible in the data detected by a sensor.

Although only exemplary embodiments of the invention are specifically described above, it will be appreciated that modifications and variations of these examples are possible without departing from the spirit and intended scope of the invention. For example, throughout the specification vibration diagnosis in a drill string is discussed. One or ordinary skill in the art would understand, using this specification, how to diagnose vibrations in other downhole tools, such as a drill bit (which may actually be reflected in vibrations of the drill string), a corer, a reamer, etc.

1. An adaptive system for diagnosing vibrations during drilling comprising:
a drilling assembly at least partially located in a wellbore;
a sensor located in the wellbore; and
a data processing unit, wherein the drilling assembly is operable to drill the wellbore and the sensor in the wellbore is operable to detect high frequency data reflecting vibrations in the drilling assembly;
wherein the data processing unit is operable to execute a classification model based on machine learning techniques which uses features extracted from the high frequency data to diagnose the type or intensity of a vibration or both in the drilling assembly.

2. The system of claim 1, wherein the drilling assembly comprises a drill string and the sensor is located on or in the drill string.

3. The system of claim 1, wherein the sensor is located on an exterior surface of the drill string.

4. The system of claim 1, wherein the sensor comprises an accelerometer.

5. The system of claim 1, wherein the data processing unit is located at a surface of the wellbore.

6. The system of claim 1, wherein the data processing unit is located in the wellbore.

7. The system of claim 1, wherein the type of vibration diagnosed is lateral, torsional, or axial.

8. The system of claim 1, wherein the features are extracted by the data processing unit.

9. The system of claim 1, wherein the system comprises an additional data processing unit the features are extracted by the additional data processing unit.

10. The system of claim 1, wherein the classification model based on machine learning techniques has been trained using visually classified data.

11. The system of claim 1, wherein the classification model based on machine learning techniques has been trained using classified data generated by a simulation model.

12. The system of claim 5, further comprising a mud pulse telemetry system or a wired drill string, wherein the sensor is operable to communicate data to the data processing unit using the mud pulse telemetry system or the wired drill string.

13. The system of claim 6, further comprising a mud pulse telemetry system or a wired drill string, wherein the data processing unit is operable to communicate the type of a vibration to a surface of the wellbore using the mud pulse telemetry system or the wired drill string.

14. The system of claim 6, further comprising a mud pulse telemetry system or a wired drill string, wherein the data processing unit is operable to also communicate the intensity of a vibration to a surface of the wellbore using the mud pulse telemetry system or the wired drill string.

15. The system of claim 1, further comprising a control unit operable to automatically take a corrective action based on the type or intensity of a vibration or both.

16. The system of claim 1, further comprising an alarm that activates a signal in response to the type or intensity of a vibration or both.

17. The system of claim 1, wherein the high frequency data is used to diagnose vibrations in real time.

18. An adaptive method of diagnosing vibrations during drilling comprising:
collecting high frequency data reflecting vibrations in a drilling assembly located at least partially in a wellbore using a sensor located in the wellbore;
extracting at least one feature from the high frequency data; and
diagnosing the type of vibration using the at least one extracted feature and a classification model based on machine learning techniques.

19. The method of claim 18, further comprising additionally diagnosing the intensity of vibration using the at least one extracted feature and a classification model based on machine learning techniques.

20. The method of claim 18, wherein the classification model based on machine learning techniques has been trained using visually classified data.

21. The method of claim 18, wherein the classification model based on machine learning techniques has been trained using classified data generated using a simulation model.

22. The method of claim 18, further comprising further training the classification model based on machine learning techniques using the high frequency data or at least one feature and the results of the diagnosing step.

23. The method of claim 18, wherein diagnosing is performed in real time.

24. The method of claim 18, wherein the vibration diagnosed is lateral, torsional, or axial.

25. The method of claim 18, further comprising reducing the amount of data using intelligent data reduction.
